(19) United States
(12) Patent Application Publication
(10) Pub. No.: US 2008/0167888 A1
(43) Pub. Date: Jul. 10, 2008

(54) Method and system for identification verification between at least a pair of entities

(75) Inventor: Thomas H. Keithley, Monkton, MD (US)

Correspondence Address: THE WEBB LAW FIRM, P.C., 700 KOPPERS BUILDING, 436 SEVENTH AVENUE, PITTSBURGH, PA, 15219, US

(73) Assignee: I4 Commerce Inc., Timonium, MD (US)

(21) Appl. No.: 11/651,142

(22) Filed: Jan. 9, 2007

(51) Int. Cl. G06Q 30/00

(52) U.S. Cl. 705/1; 705/50; 705/51

(57) ABSTRACT

A method for identification verification between at least a pair of entities. The method includes the steps of: (a) specifying, by a first entity, at least one identification private credential attribute; and (c) incorporating the at least one identification private credential attribute in a communication between a second entity and the first entity. An apparatus and system are also disclosed.

### BACKGROUND OF THE INVENTION

1. Field of the Invention

The present invention is related generally to identification systems and relationships between entities, such as consumers and institutions, merchants, corporations and other entities and, in particular, to a method and system for verifying the identification between at least a pair of entities, such as in an online environment in a relationship between a first entity, such as a consumer, and a second entity, such as an institution, merchant, bank, credit issuer, etc.

2. Description of Related Art

In order to enable convenient purchases of goods and services by consumers, the financial service industry has developed many alternative payment methods that allow a consumer to engage in a transaction and receive goods and services on credit. For example, such alternative payment methods may include checks, ATM or debit cards, credit cards, charge cards, etc. Prior to the birth of virtual commerce, as discussed below, such payment options provided adequate convenience and transactional security to consumers and merchants in the marketplace. Virtual commerce and the growth of the Internet as a medium for commerce have placed pressure on the payment options discussed above on the convenience, transactional security and profitability by the credit issuer. Currently, available payment options include significant shortcomings when applied to remote purchasers, such as purchases where the buyer and the seller (that is, the merchant) are not physically proximate during the transaction. Specific examples of remote purchases are mail order, telephone order, the Internet and wireless purchases.

As global commerce increases, security in transactions is more and more difficult to obtain. Many transactions are consummated by fraudsters, identification thieves and others that have somehow obtained the appropriate identification information regarding a consumer. For example, credit cards may be convenient to the consumer, but are subject to fraudulent use via theft of the account number, expiration date and address of the consumer. This, in turn, places the credit issuer at risk of offering credit to an uncreditworthy consumer, being the subject of consumer fraud or providing authorization to a merchant to provide services or ship goods to a fraudulent source.

Current available payment options include significant shortcomings when applied to remote purchasers, such as purchases where the buyer and the seller (that is, the merchant) are not physically proximate during the transaction. Further, regardless of the proximity of the consumer and the merchant, merchants and credit issuers alike continue to battle the problem of fraudulent purchases. Each new payment option and every new sales channel (instore, telephone, mail and Internet) have, in turn, spawned innovation on the part of consumers willing to perpetrate fraud in order to obtain goods and services without paying for them.

In recent years, the birth of the Internet commerce industry and the continued growth in mail order and telephone order commerce have pushed the credit card to the forefront of these battles. Typically, merchants are forced to rely on credit cards because it is currently their only option in the remote purchase environment. However, regardless of the type of credit offered, low transactional security is offered to both merchants and consumers. This leads to significant cost for the consumers and the merchants, such as the consumer cost including the impairment of their credit record, the inconvenience of changing all of their credit card accounts and the financial cost in resolving the situation. Merchant costs may include the mitigation of fraud losses, including the cost in incremental labor, hardware and software to implement additional security checks in their sales/order entry software, higher transaction processing expense in the form of discount rates for credit cards and NSF fees for checks and higher fraud charge-offs for undetected fraudulent purchases.

With the continuing speed and ability of a consumer to gain credit, whether at a point-of-sale or through the use of an existing account, identity theft and fraud are on the increase. However, as is easily evident in today's marketplace, merchants are often more interested in providing a consumer with quick and efficient service with little hassle regarding the consumer's identity. Still further, such fraudsters are capable of stealing or otherwise illicitly obtaining certain static proprietary symbols (e.g., a corporate logo, a service logo, a specific message format, etc.) for use in “fishing” for the victim's data. For example, if the fraudster obtains a financial institution's logo and message format, he or she will send a message to the potential victim to enter their account or other valuable information. The victim, used to seeing the logo and message format, may, in many cases, provide this data to the fraudster, and lose considerable money as a result.

Prior art systems and methods have been developed in an attempt to stop or curtail this type of “fishing” activity. For example, some prior art systems have been developed which use non-machine readable blur code words or numbers that must be input by a human. However, this may only be effective for automated “fishing” techniques. Other attempts to stop this activity include requiring photographs on credit cards, and using ink-based security paper on checks. However, these methods have not been effective in many areas, including the prevention of online “fishing” expeditions. Accordingly, there is considerable room in the art for additional security techniques to prevent the activities of these fraudsters.

### SUMMARY OF THE INVENTION

It is, therefore, an object of the present invention to provide a method and system for identification verification between at least a pair of entities that overcomes the drawbacks and deficiencies of the prior art. It is another object of the present invention to provide a method and system for identification verification between at least a pair of entities that ensures transactional and communication security between entities. It is yet another object of the present invention to provide a method and system for identification verification between at least a pair of entities that allows for the verification of a second entity and subsequent secure communication between a first entity and a second entity. It is a still further object of the present invention to provide a method and system identification verification between at least a pair of entities that prevents “fishing” and other identification fraud issues, e.g., in an online environment and for online and/or electronic communications.

Accordingly, the present invention is directed to a method for identification verification between at least a pair of entities. This method includes the steps of: (a) specifying, by a first entity, at least one identification private credential attribute; and (b) incorporating the at least one identification private credential attribute in a communication between a second entity and the first entity.

In another aspect, the present invention is directed to a system for identification verification between at least a pair of entities. This system includes a storage mechanism having an identification database thereon, and the database has a plurality of data fields populated with data regarding a first entity, an identification of the first entity, a second entity, an identification of the second entity, at least one identification private credential attribute or any combination thereof. Further, the system includes a processor mechanism in communication with the storage mechanism, and this processor mechanism is configured to: (i) associate the first entity with the least one identification private credential attribute; and (iii) certify the authenticity of a communication between the first entity and a second entity using the at least one identification private credential attribute.

The present invention is further directed to an apparatus for identification verification between at least a pair of entities. This apparatus includes: means for specifying, by a first entity, at least one identification private credential attribute; and means for incorporating the at least one identification private credential attribute in a communication between a second entity and the first entity.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a step flow diagram of one embodiment of a method for identification verification between at least a pair of entities according to the present invention;

FIG. 2 is a schematic view of one embodiment of a method and system for identification verification between at least a pair of entities according to the present invention;

FIG. 3 is a schematic view of a further embodiment of a method and system for identification verification between at least a pair of entities according to the present invention;

FIG. 4 is an example communication between a pair of entities utilizing a method and system for identification verification between at least a pair of entities according to the present invention;

FIG. 5 is a further example communication between a pair of entities utilizing a method and system for identification verification between at least a pair of entities according to the present invention; and

FIG. 6 is a schematic view of a further embodiment of an apparatus and system for identification verification between at least a pair of entities according to the present invention.

### DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The present invention is directed to a method 100 and system 10 for use in identification verification between at least a pair of entities, such as a first entity 12 (or first entity system 13) and a second entity 14 (or second entity system 15). In particular, the method 100 and system 10 are used to ensure secure and verified communication between the first entity 12 and the second entity 14 utilizing an identification private credential attribute 16.

The first entity 12 may be, for example, a consumer that has, in the past, engaged in some transaction or communication with the second entity 14, which may be, for example, a merchant, an institution, a bank, a credit issuer, a corporate entity, etc. Therefore, the present invention is useful in connection with providing safe and secure communications between the first entity 12 and the second entity 14. Further, the method 100 and system 10 of the present invention can be used in connection with a variety and any quantity of pairs of entities, and over a variety of media, such as in the mail, at an instore location, over the telephone, in an online environment, etc. In addition, the presently-invented method 100 and system 10 may be used between a single consumer and a group of verified second entities 14.

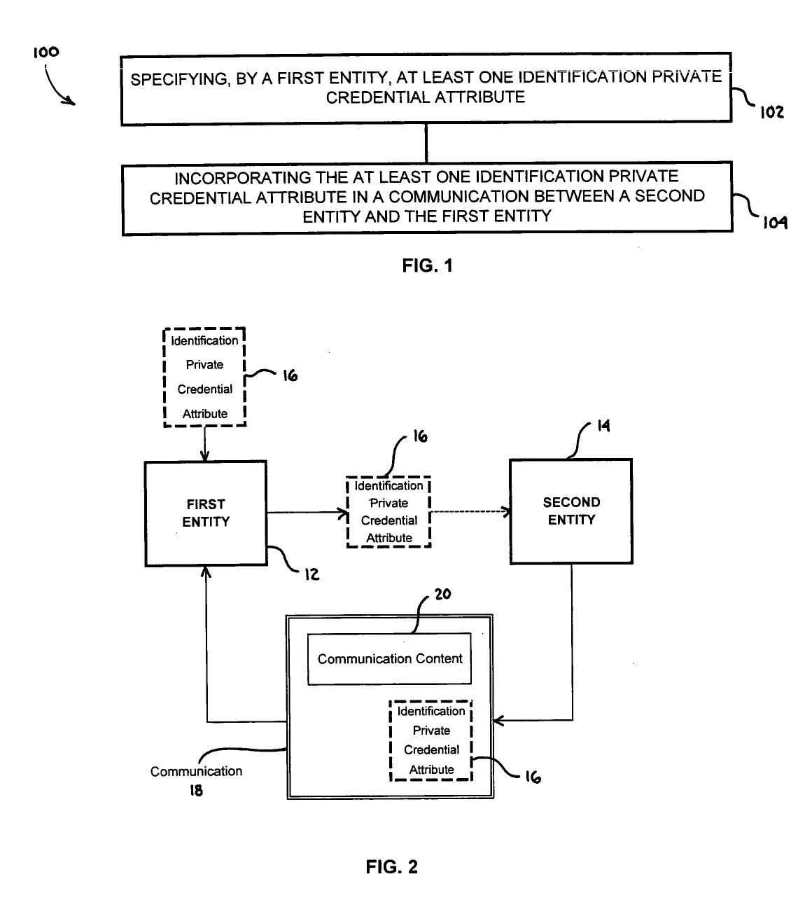

As seen in FIG. 1, the present invention includes a method 100 for identification verification between at least a pair of entities. This method 100 includes the steps of: specifying, by the first entity 12, at least one identification private credential attribute 16 (Step 102); and incorporating the identification private credential attribute 16 in a communication 18 between the second entity 14 and the first entity 12 (Step 104). Accordingly, the identification private credential attribute 16 serves as a private credential or secure credential that is either known only to the first entity 12 (such as in the case where the identification private credential attribute 16 is a characteristic of the communication 18 modified on the computer of the first entity 12), or, alternatively, shared only between the first entity 12 and the second entity 14. Therefore, all subsequent communications 18 between the entities 12, 14 or systems 13, 15 occur in a secure environment.

The identification private credential attribute 16 may be a selected aspect or characteristic for use in verifying the authenticity of the second entity 14. For example, the identification private credential attribute 16 may be a modified attribute on the display of a first entity system 13 of the first entity 12, e.g., wallpaper, background, font, etc. In addition, the identification private credential attribute 16 may be a separate file that is displayed on the computer, e.g., a .jpg file, a .gif file, an .mpeg file, an audio file, etc. This file would be used by and incorporated into only verified messages and communications 18 from the second entity 14 to the first entity 12.

The identification private credential attribute 16 is incorporated into the communication 18 in two primary manners: (1) automatically by the first entity system 13 when the communication 18 and/or second entity 14 is verified by the system 10; and (2) automatically or manually by the second entity 14 (or second entity system 15), who only has access to the identification private credential attribute 16 after the second entity 14 has been verified. The automatic incorporation of the identification private credential attribute 16, whether a characteristic of the display of the communication 18 or a separate file, is preferable, since such a step provides added security by not sharing the identification private credential attribute with the second entity 14. Accordingly, since only the first entity 12 (or the first entity system 13) has access to the identification private credential attribute 16, third-party knowledge thereof is eliminated. Therefore, the identification private credential attribute 16 may take the form of a customizable desktop characteristic on the first entity system 13 of the first entity 12.

The presently-invented method 100 and system 10 is equally useful in a variety of applications, including both the online environment, over the telephone, in a physical mailing or at the point of sale. Of course, outside of the online environment, the remaining “physical” or “non-virtual” situations would likely require provision of the identification private credential attribute 16 to the second entity 14. Specifically, the identification private credential attribute 16 would be communicated to the second entity 14 for use in incorporation thereof into the physical or telephonic communication. For example, when the identification private credential attribute 16 is a wallpaper or font choice, this attribute 16 could be used both in connection with an online communication 18, as well as a physical (mailed or faxed) communication 18.

The present invention is further directed to a system 10 for identification verification between at least a pair of entities or systems/computer of such entities. As seen in schematic form in FIG. 2, the first entity 12 specifies or obtains an identification private credential attribute 16. Upon a subsequent communication 18 from the second entity 14 to the first entity 12, this identification private credential element 16 is utilized. In particular, the identification private credential attribute 16 is incorporated with or otherwise included with the remaining communication content 20 of the communication 18. Accordingly, the first entity 12 can be assured that the communication 18 has been verified and is authentic, and further that this communication 18 has been sent from the verified second entity 14. Of course, it is also envisioned that this identification private credential attribute 16 can be used in any and all communications 18 whether initiated by the first entity 12 or the second entity 14, which will also serve to authenticate the identity of the first entity 12. In another embodiment, and when required in certain application, this identification private credential attribute 16 may be transmitted to or otherwise communicated to the second entity 14.

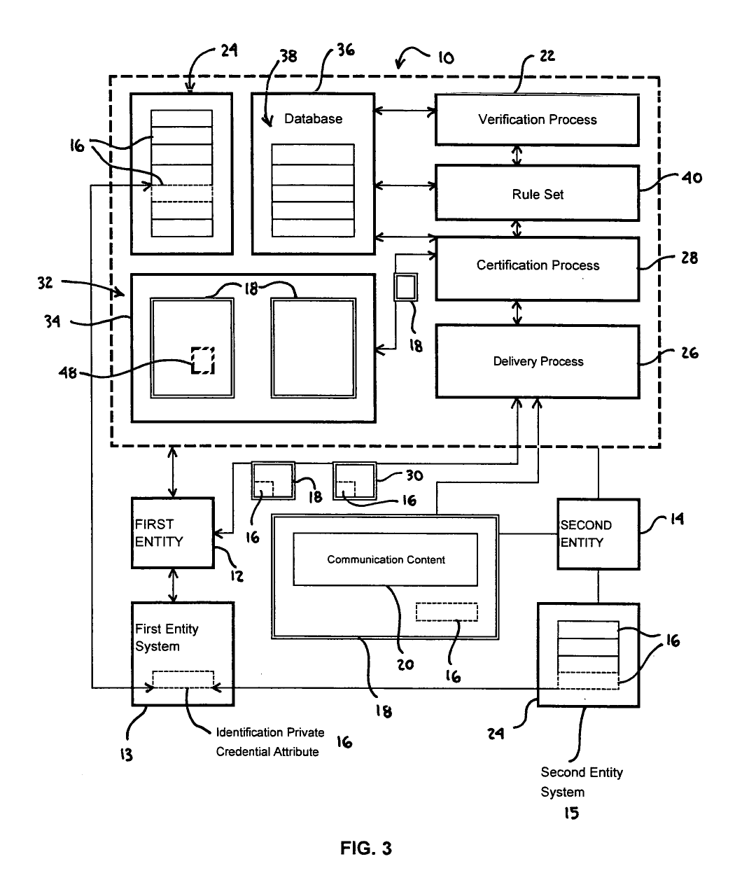

FIG. 3 illustrates one preferred embodiment of the system 10 having additional functionality. For example, the method 100 and system 10 may further include the step of verifying the identification of the second entity 14 using a verification process 22. In particular, this verification process 22 would occur prior to automatically incorporating the identification private credential attribute 16 into the communication 18, or otherwise providing the identification private credential element 16 to the second entity 14. Since the identification private credential element 16 is an attempt to provide secure communications, it will be particularly beneficial to ensure that the second entity 14 is both authenticated and verified prior to automatically incorporating (such as modifying a desktop setting of the first entity 12) this identification private credential attribute 16 or initially sending it to the second entity 14. Of course, this verification process 22 may also be used to verify the identification of the first entity 12 prior to allowing him or her to obtain an identification private credential element 16 in the name of the user. Therefore, it is envisioned that the first entity 12 must provide appropriate and verifiable identification data in order to initiate and/or obtain this identification private credential attribute 16.

As discussed above, the first entity 12 and the second entity 14 can be a variety of places, persons and entities. For example, the entities 12, 14 may be an individual, a consumer, a purchaser, a customer, a provider, a corporation, an institution, a merchant, a service provider, a credit issuer, a bank, etc. Accordingly, the use of this identification private credential attribute 16 effectuates secure communications 18 through and between a variety of different entities 12, 14.

In another preferred and non-limiting embodiment, and as seen in FIG. 3, the method 100 and system 10 may also allow the first entity 12 to select or specify an identification private credential attribute 16 of his or her choosing. For example, the selection may be made from a group of available identification private credential attribute 16. This group may be an itemized list 24 of available identification private credential attributes 16, e.g., audio file, video file, picture file, modifiable characteristics, available and modifiable desktop settings, etc., which are provided by a third-party system, the second entity 14 or second entity system 15 or already available on a first entity system 13 of the first entity 12. For example, these identification private credential elements 16 may be housed in a database or other grouping of selectable identification private credential attributes 16.

Of course, it is envisioned that the first entity 12 may create his or her identification private credential attribute 16. For example, the identification private credential element 16 may be a background, a wallpaper, a font, a design, a color, a pattern, a word, an expression, a phrase, a watermark, a symbol, indicia, an audio clip, a picture, a video, an audio element, a video element, an audiovisual element, execution of an action, execution of a program, a postmark, a characteristic, an aspect, a state, etc. Therefore, for example, if the first entity 12 chooses an audio clip as his or her identification private credential element 16, each and all subsequent communications 18 from the second entity 14 to the first entity 12 would incorporate this identification private credential attribute 16 and cause the audio clip to sound during distribution or display of the communication 18. In this manner, the first entity 12 would be assured that the communication 18 is authentic and has been received from a verified second entity 14. Further, as discussed above, if the communication 18 is verified and/or certified by the system 10, the identification private credential attribute 16 in the form of a wallpaper and font would be automatically incorporated into the communication 18 by the system 10 and/or the first entity system 13.

In a further embodiment, after the first entity 12 has selected or specified the identification private credential attribute 16, this identification private credential attribute 16 may be configurable or modifiable by the first entity 12. Therefore, after choosing from the itemized list 24, the first entity 12 may further modify or otherwise change and configure the identification private credential attribute 16, thereby allowing the first entity 12 to render the identification private credential attribute 16 additionally unique and individualized.

Still further, the identification private credential attribute 16 may be assigned by the second entity 14 to the first entity 12. Such assignation would ensure that not only is the communication 18 from the second entity 14 to the first entity 12 secure and authenticated, but would also allow for the verification and authentication of the identity of the first entity 12 in any further communications 18. In addition, such assignation would allow the second entity 14 to control and selectively provide these identification private credential attributes 16 to predetermined and verified first entities 12. For example, the second entity 14 may only assign the identification private credential attribute 16 to the first entity 12 after ensuring that the first entity 12 is verified, authenticated and, perhaps, meets certain criteria for engagement with the second entity 14. For example, in a credit application, the identification private credential attribute 16 may only be assigned to the first entity 12 if the first entity 12 meets the appropriate credit and consumer requirements of the second entity 14, which, in this case, may be a credit issuer, bank, etc.

Due to the possibilities of identity theft and other similar and ongoing problems, the method 100 and system 10 may also engage in additional and periodic verification through the verification process 22. Such verification may include verifying the first entity 12, the second entity 14, the identification private credential attribute 16, any specific communication 18, etc. For example, the first entity 12 and/or second entity 14 may be periodically verified through some electronic communication, voice communication, secure communication, encrypted communication, paper communication, etc. This means that the system 10 would automatically engage in some verification through the verification process 22 in order to ensure the safety and security of the environment.

It is also envisioned that the system 10 will periodically prompt the first entity 12 to obtain a different identification private credential attribute 16. Accordingly, the first entity 12 would obtain (whether through selection, creation or specification) a different identification private credential attribute 16, and this different identification private credential attribute 16 would be incorporated into subsequent communications 18 between the second entity 14 and the first entity 12. Again, such periodic modification and configuration would add an additional layer of safety and security to the communication environment.

In another embodiment, the system 10 includes a delivery process 26 and a certification process 28. In particular, the delivery process 26 would act as an intercepting agent and partition between communications 18 between the second entity 14 and the first entity 12. Therefore, all subsequent communications 18 would be run through the delivery process 26. The certification process 28 would be used to authenticate the communication 18 using the identification private credential element 16. If certified, the communication 18 would be delivered through the delivery process 26 to the first entity 12. However, if the communication 18 is not certified (such as including an incorrect identification private credential attribute 16 or no identification private credential element 16, or failing the verification process 22), the communication 18 would be prevented from directly reaching the first entity 12.

If the communication 18 is not certified by the certification process 28, the system 10 will deliver a message 30 to the first entity 12 notifying them of the existence of this uncertified communication 18. This message 30 would incorporate the appropriate identification private credential attribute 16, such that the first entity 12 would be assured that the message 30 is authentic and has been appropriately delivered from the system 10. This means that it is also envisioned that the first entity 12 and the system 10 itself may have some identification private credential attribute 16 associated therewith to ensure a secure communication 18.

In many instances, the first entity 12 may still wish to view the uncertified communication 18. Therefore, the system 10 may include some safe environment 32, such as a secure website or other secure medium to allow the first entity 12 to safely view and understand the contents of the uncertified communication 18. Further, the safe environment 32 may be in the form of some interactive interface 34 that allows the user (or first entity 12) to manage, manipulate and otherwise interact with the communications 18. It is envisioned that the interactive interface 34 could be used to manage all aspects of the communications 18 received by the first entity 12, such as in the form of an e-mail inbox or the like. Accordingly, the uncertified communications 18 would be segregated and placed in a secure location for viewing by the first entity 12, while the certified communications 18 would be allowed direct delivery to the inbox.

As discussed above, the presently-invented method 100 and system 10 are useful in connection with any communication events, whether electronic, paper, telephonic, in-person etc. However, the method 100 and system 10 of the present invention are particularly useful in connection with electronic communications 18 in an online environment. For example, electronic communication 18 may be in the form of an e-mail, an instant message, a window, a pop-up window, a program screen, an interface, an interactive interface, a display, etc. While the problem of “fishing” is predominantly in the online environment, the use of this identification private credential attribute 16 would also be beneficial in other situations and environments. For example, albeit to a lesser extent, such “fishing” does occur on the telephone by fraudsters seeking private data from homeowners. In such a situation, the identification private credential attribute 16 may be a sound clip or other audio-based identification private credential attribute 16.

In a further embodiment, and as seen in FIG. 3, the system 10 may include a database 36. This database 36 includes multiple fields 38 populated with data regarding the first entity 12, the identification of the first entity 12, the second entity 14, the identification of the second entity 14, the identification private credential element 16, the first entity system 13, the second entity system 15, etc. Accordingly, this database 36, which may be housed on or with a third-party system 10 or as part of the first entity system 13 of the first entity 12, and would act as a central repository of all necessary data points and fields for effectively engaging in the secure communications, verification, certification and delivery processes. Accordingly, the system 10 may also include a rule set 40, which would use the fields 38 in the database 36 for engaging in the certification process 28, the verification process 22 and/or the delivery process 26.

In this manner, the rule set 40 would be applied to the communications 18 between the second entity 14 and the first entity 12. This rule set 40 would contain multiple and configurable rules for making decisions about delivery of communications 18 between the second entity 14 and the first entity 12. In addition, this rule set 40 may be established by the second entity 14, the first entity 12 and/or the system 10.

In one example, the rule set 40 is created or otherwise configured by the first entity 12. In such an embodiment, the first entity 12 may not have a desire to have the identification private credential attribute 16 incorporated in all communications 18 to the first entity 12. For example, certain private communications (such as between family members or from known entities) would not require certification and may be directly delivered by the delivery process 26 to the first entity 12, such as at the interactive interface 34. As a further example, the rule set 40 may include rules that parse the communication content 20 of the communication 18 and decide whether the communication 18 is likely an act of “fishing”, or requests any private data from the first entity 12 (such as financial data, passwords, user identification data, etc.). Therefore, the rule set 40 can be used to manage all communications 18 to the first entity 12.

As discussed above, the method 100 and system 10 may be used and enabled through the first entity 12 and/or the second entity 14. Of course, it may be particularly useful and additionally secure to have the system 10 set up as a third-party system separate and apart from the users, i.e., the first entity 12, the first entity system 13, the second entity 14 and the second entity system 15. Again, such an arrangement would allow an additional layer of safety and security to the communications 18.

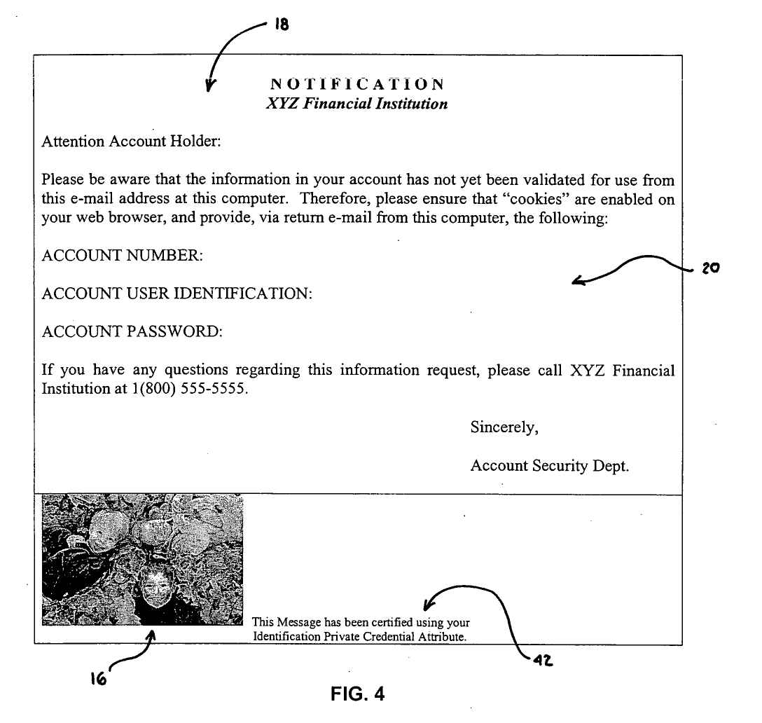

An example communication 18 is illustrated in FIG. 4. In this example, the communication 18 is from a financial institution and is asking for sensitive information from the first entity 12. In particular, the communication content 20 includes a request for a return e-mail from the computer of the first entity 12 including the first entity 12 account number, account user identification and account password. As a further example, this may be the type of request that would be flagged by the rule set 40 and subject to the certification process 28 using the identification private credential element 16.

In any case, this communication 18 has been delivered to the first entity 12. Specifically, the communication 18 has been delivered because it incorporates the identification private credential attribute 16. In this example, the identification private credential attribute 16 is a picture that has been generated by the first entity 12 and either automatically incorporated into the communication 18, or, alternatively, previously provided to the verified second entity 14. In addition, this communication 18 includes a certification message 42 from the system 10, which additionally assures the first entity 12 that the communication 18 has been certified in the certification process 28. This means that the first entity 12 can appropriately respond to the communication 18 since it has been verified and certified as being authentic.

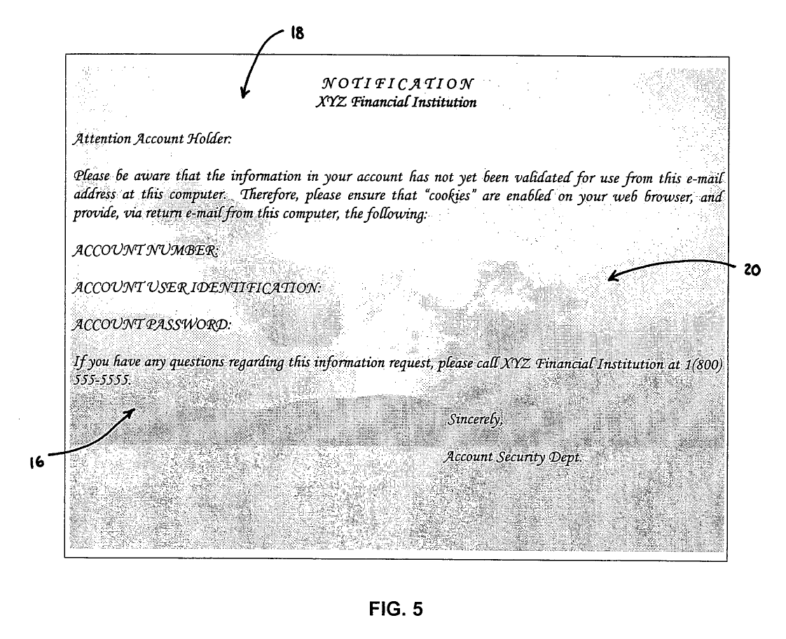

Another example communication 18 is illustrated in FIG. 5. Again, the communication content 20 is requesting certain private information from the first entity 12. This communication 18 has also been certified and includes the appropriate identification private credential attribute 16 and certification message 42. In this embodiment, the identification private credential attribute 16 is in the form of a background or wallpaper, as well as a specified font, that has either been previously specified to and automatically generated by the first entity system 13 of the first entity 12, previously sent to a verified second entity 14, or selected from an itemized list 24 for use as the identification private credential attribute 16.

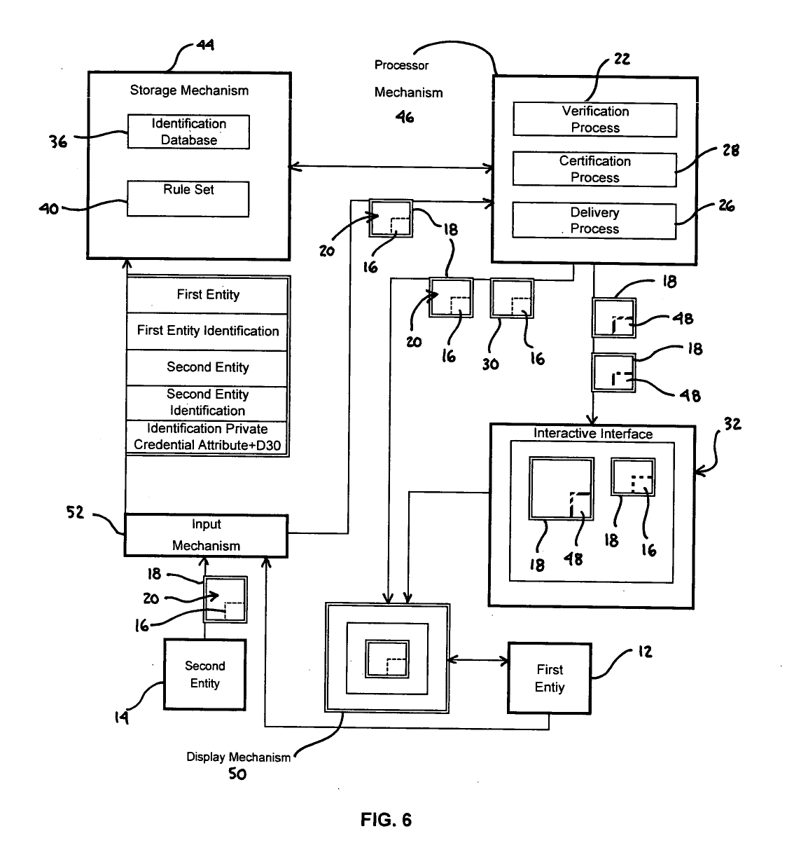

A further embodiment of the system 10 is illustrated in FIG. 6. This system 10 includes a storage mechanism 44, which includes an identification database 36 having multiple fields 38 therein as discussed above. Further, the system 10 includes a processor mechanism 46 in communication with the storage mechanism 44. This processor mechanism 46 is configured to associate the first entity 12 with the identification private credential element 16, and certify the authenticity of the communication 18 between the second entity 14 and the first entity 12 using the identification private credential attribute 16. Alternatively, the processor mechanism 46 is configured to transmit, to the second entity 14, the identification private credential attribute 16 of the first entity 12. As discussed above, a rule set 40 can be used, and this rule set 40 may be housed on the storage mechanism 44 for use in the certification process 28. Further, the processor mechanism 46 includes or is programmed to enable the verification process 22, certification process 28 and delivery process 26, as discussed above.

In this manner, the processor mechanism 46 intercepts the communications 18 from the second entity 14 (or second entity system 15) to the first entity 12 (or first entity system 13), and, if the communication 18 is certified, allow the communication 18 to be delivered to the first entity 12, and, if the communication 18 is not certified, prevents the communication 18 from directly reaching the first entity 12. Of course, the processor mechanism 46 and/or storage mechanism 44 are used to apply the rule set 40, and this rule set 40 may be configurable or modifiable by the first entity 12, the second entity 14, the system 10, etc., as discussed above.

As seen in FIG. 6, various communications 18 have been intercepted by the delivery process 26 and processed through the certification process 28. The communications 18 including the appropriate identification private credential attribute 16 are delivered directly to the first entity 12, while the uncertified communications 18 are provided indirectly to the first entity 12 through the interactive interface 34. Also seen in this embodiment is the use of an incorrect identification private credential attribute 48. Accordingly, it would appear that some entity is attempting to duplicate the form and format of a certified communication 18, but has used the incorrect identification private credential attribute 48, which has been flagged and otherwise processed by the system 10. Accordingly, it is envisioned that this information can be used to track or otherwise investigate the source of such fraudulent communications 18.

As discussed above, the presently-invented method 100 and system 10 are particularly useful in on online environment. Therefore, the first entity 12 would use a display mechanism 50 to both communicate and otherwise manage all communications 18, whether certified or uncertified. This would be particularly useful when using the method 100 and system 10 of the present invention as a mail delivery (or e-mail) system. Additionally, in such an environment, the second entity 14 would be in communication with an input mechanism 52. The input mechanism 52 would allow the second entity 14 to provide the communication 18 to the first entity 12 through the system 10. Of course, this input mechanism 52 may also be used to provide all the data required for the system 10, such as to the storage mechanism 44. In this case, the input mechanism 52 would act as an interface between all incoming communications 18, data, etc.

In this manner, the presently-invented method 100 and system 10 provide for the appropriate identification verification between at least a pair of entities that avoids various fraudulent activities of third parties. In addition, the present invention ensures transactional and communication security between the first entity 12 and the second entity 14. In addition, the method 100 and system 10 of the present invention prevent and/or drastically reduce various “fishing” activities, as well as other identification fraud issues. Therefore, the present invention is particularly useful in an online environment for online and/or electronic communications.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for identification verification between at least a pair of entities, comprising the steps of:
(a) specifying, by a first entity, at least one identification private credential attribute; and
(c) incorporating the at least one identification private credential attribute in a communication between a second entity and the first entity.

2. The method of claim 1, wherein the communication is an electronic communication, the method further comprising the steps of:
verifying the authenticity of the second entity; and
if verified, automatically incorporating the identification private credential attribute into the electronic communication.

3. The method of claim 2, wherein if the authenticity of the second entity is not verified, the method further comprises the step of providing an indication to the first entity regarding the authenticity of the electronic communication.

4. The method of claim 1, wherein, prior to step (c), the method further comprises the step of providing, to the second entity, the at least one identification private credential attribute for use in communication with the first entity.

5. The method of claim 4, wherein, prior to the step of providing the at least one identification private credential attribute, the method further comprises the step of verifying the identification of the second entity.

6. The method of claim 1, wherein, prior to step (a), the method further comprises the step of verifying the identification of the first entity.

7. The method of claim 1, wherein the first entity, the second entity, or any combination thereof is an individual, a consumer, a purchaser, a customer, a provider, a corporation, an institution, a merchant, a service provider, a credit issuer or any combination thereof.

8. The method of claim 1, wherein step (a) further comprises selection, by the first entity, of the identification private credential attribute.

9. The method of claim 8, wherein the selection is from a group of available identification private credential attributes.

10. The method of claim 9, wherein the group is an itemized list of a plurality of available identification private credential attributes.

11. The method of claim 8, wherein, after selection, the selected identification private credential attribute is configurable or modifiable by the first entity.

12. The method of claim 1, wherein step (a) further comprises creation or setting, by the first entity, of the identification private credential attribute.

13. The method of claim 1, wherein step (a) further comprises assignation, by the second entity to the first entity, of the identification private credential element.

14. The method of claim 1, further comprising the step of periodically verifying the first entity, the second entity, the identification private credential attribute, the communication or any combination thereof.

15. The method of claim 1, further comprising the step of periodically verifying the first entity or the second entity through electronic communication, voice communication, secure communication, encrypted communication, paper communication or any combination thereof.

16. The method of claim 1, further comprising the steps of:
prompting the first entity to obtain a different identification private credential attribute;
obtaining, by the first entity, a different identification private credential attribute; and
incorporating the different identification private credential attribute in a subsequent communication between the second entity and the first entity.

17. The method of claim 1, further comprising the steps of:
intercepting a communication from the second entity to the first entity;
certifying the authenticity of the communication using the identification private credential attribute;
if certified, allowing the communication to be delivered to the first entity; and
if not certified, preventing the communication from directly reaching the first entity.

18. The method of claim 17, wherein if the communication is not certified, providing a message to the first entity identifying the uncertified communication.

19. The method of claim 18, wherein the message incorporates the identification private credential attribute.

20. The method of claim 17, further comprising the step of allowing the first entity to view the uncertified communication in a safe environment.

21. The method of claim 1, wherein the identification private credential element is a background, a wallpaper, a font, a design, a color, a pattern, a word, an expression, a phrase, a watermark, a symbol, indicia, an audio clip, a picture, a video, an audio element, a video element, an audiovisual element, execution of an action, execution of a program, a postmark, a characteristic, an aspect, a state or any combination thereof.

22. The method of claim 1, wherein the communication is an electronic communication in an online environment.

23. The method of claim 22, wherein the electronic communication is in the form of an e-mail, an instant message, a window, a pop-up window, a program screen, an interface, an interactive interface, a display or any combination thereof.

24. The method of claim 1, further comprising the steps of:
building a database having a plurality of data fields populated with data regarding the first entity, the identification of the first entity, the second entity, the identification of the second entity, the at least one identification private credential attribute or any combination thereof;
building a rule set for certifying communications between the first entity and the second entity; and
applying the rule set to at least one communication between the second entity and the first entity.

25. The method of claim 24, wherein the database is resident on a first entity system, a second entity system, a third-party system or any combination thereof.

26. A system for identification verification between at least a pair of entities, comprising:
a storage mechanism having an identification database thereon, the database having a plurality of data fields populated with data regarding a first entity, an identification of the first entity, a second entity, an identification of the second entity, at least one identification private credential attribute or any combination thereof;
a processor mechanism in communication with the storage mechanism and configured to:
(i) associate the first entity with the least one identification private credential attribute; and
(ii) certify the authenticity of a communication between the first entity and the second entity using the at least one identification private credential attribute.

27. The system of claim 26, wherein the storage mechanism further comprises a rule set for certifying communications between the first entity and the second entity; and the processor mechanism is further configured to apply the rule set to at least one communication between the second entity and the first entity.

28. The system of claim 26, wherein the processor mechanism is further configured to intercept a communication from the second entity to the first entity, and, if the communication is certified, allow the communication to be delivered to the first entity, and, if the communication is not certified, prevent the communication from directly reaching the first entity.

29. The system of claim 27, wherein if the communication is not certified, the processor mechanism transmits a message to the first entity identifying the uncertified communication.

30. The system of claim 27, further comprising an interactive interface for allowing the first entity to view the uncertified communication in a safe environment.

31. The system of claim 26, wherein the processor mechanism is further configured to verify the identification of the first entity, the second entity or any combination thereof.

32. The method of claim 23, wherein the identification private credential element is a background, a wallpaper, a font, a design, a color, a pattern, a word, an expression, a phrase, a watermark, a symbol, indicia, an audio clip, a picture, a video, an audio element, a video element, an audiovisual element, execution of an action, execution of a program, a postmark, a characteristic, an aspect, a state or any combination thereof.

30. An apparatus for identification verification between at least a pair of entities, comprising:
means for specifying, by a first entity, at least one identification private credential attribute; and
means for incorporating the at least one identification private credential attribute in a communication between a second entity and the first entity.
